(19) United States
(12) Patent Application Publication
(10) Pub. No.: US 2024/0251777 A1
(43) Pub. Date: Aug. 1, 2024

(54) INSECT TRAP

(71) Applicant: PIC Corporation, Linden, NJ (US)

(72) Inventors: Eric Rubel, Westfield, NJ (US); David L. Lowe, Port Monmouth, NJ (US); Lawrence E. Bradford, Westfield, NJ (US)

(21) Appl. No.: 18/425,451

(22) Filed: Jan. 29, 2024

Related U.S. Application Data
(60) Provisional application No. 63/535,456, filed on Aug. 30, 2023.
(60) Provisional application No. 63/442,011, filed on Jan. 30, 2023.

(51) Int. Cl. A01M 1/14

(52) U.S. Cl. CPC A01M 1/145

(57) ABSTRACT

An insect trap includes a light to attract insects to a sticky or adhesive material and a power source to allow use in a variety of locations.

### CROSS-REFERENCE TO RELATED APPLICATIONS

The present application claims priority to and benefit of U.S. Provisional Patent Application Ser. No. 63/535,456 filed Aug. 30, 2023 entitled INSECT TRAP and U.S. Provisional Patent application Ser. No. 63/442,011 filed Jan. 30, 2023 entitled INSECT TRAP, the entire content of each of which is hereby incorporated by reference herein.

### BACKGROUND

### Field of the Disclosure

The present invention relates to an insect trap including a sticky or adhesive material configured to trap insects and a light element to attract insects.

### Related Art

Conventional insect traps using sticky or adhesive material are commonly are limited to particular locations which makes them impractical for many uses.

Accordingly, it would be beneficial to provide an insect trap that avoids these and other problems.

### SUMMARY

It is an object of the present disclosure to provide an insect trap including a sticky or adhesive material configured to trap insects with a light portion to attract insects and an internal power source.

An insect trap in accordance with an embodiment of the present disclosure includes: a base; a body mounted in the base, the body including: a front wall; a rear wall mounted opposite the front wall; at least one sidewall connecting the front wall and the rear wall; wherein the front wall, rear wall at least one sidewall and base define a central chamber and the central chamber includes an adhesive material; a light directing light into the central chamber to attract insects into the central chamber; and a plurality of openings formed in at least one or the front wall and the rear wall configured to allow insects to pass not the central chamber.

In embodiments, the insect trap includes a power source mounted in the base and electrically connected to the light.

In embodiments, the insect trap includes a recharging circuit electrically connected to the power source and configured to charge the power source.

In embodiments, the base includes a charging port configured to receive a plug connected to a charging wire.

In embodiments, the adhesive material is provided on at least one of the front wall and the rear wall.

In embodiments, an input element operably connected to the light and configured to turn the light on and off.

In embodiments, the light further comprises one or more light sources mounted in the base.

In embodiments, the insect trap includes a lens mounted in the base to direct light from the light into the central chamber.

In embodiments, the insect trap includes a substrate mounted in the central chamber, wherein the adhesive material is provided on the substrate.

In embodiments, the body is removable from the base to allow access to the central chamber.

An insect trap in accordance with an embodiment of the present disclosure includes: a body, wherein the body incudes a lower portion and an upper portion mounted on the lower portion, the lower portion including: a chamber: a plug extending from a rear of the lower portion and configured for electrical connection to an electrical outlet; and a light mounted on a top of the lower portion and configure to emit light; the upper portion including: a front wall; a trap holder mounted behind the front wall including a recess including an adhesive material, wherein light from the light portion is projected toward the trap holder to attract insects to the adhesive material.

In embodiments, the lower portion includes: a front wall; a first sidewall connected to the front wall; a second sidewall connected to the front wall opposite the first sidewall; a rear wall connecting the first sidewall and second sidewall; and a bottom wall connecting the front wall, wherein the chamber is defined by the front wall, first sidewall, second sidewall, rear wall and bottom wall.

In embodiments, the insect trap includes a plug housing provided in the rear wall and the plug extends from the plug housing.

In embodiments, the plug is pivotally attached to the plug housing to move from an extended position in which the plug extends substantially perpendicular to the rear wall and a second position in which the plug is received in a recess in the plug housing such that it is flush with the rear wall.

In embodiments the insect trap includes a control circuit mounted in the chamber and connected to the light to control emission of light.

In embodiments, the insect trap includes a printed circuit board, wherein the control circuit provided on the printed circuit board.

In embodiments, the insect trap includes a power source operably connected to the control circuit and the light to provide power to the control circuit and the power source.

In embodiments, the insect trap includes a first input device connected to the control circuit and configured to receive input from a user to control the light.

In embodiments, the first input device is a three position switch used to activate the light, deactivate the light and the light on a timer.

In embodiments, the insect trap includes a light sensor connected to the control circuit and configured to provide light information associated with a light level around the insect trap, wherein the control circuit activates the light based on the light information.

In embodiments, the control circuit activates the light for a predetermined period of time.

### BRIEF DESCRIPTION OF THE DRAWINGS

The above and related objects, features and advantages of the present disclosure will be more fully understood by reference to the following, detailed description of the preferred, albeit illustrative, embodiments of the present invention when taken in conjunction with the accompanying figures, wherein:

FIG. 1 illustrates a front perspective view of an insect trap in accordance with an embodiment of the present disclosure;

FIG. 2 illustrates a front view of the insect trap of FIG. 1 in accordance with an embodiment of the present disclosure;

FIG. 3 illustrates a side view of the insect trap of FIG. 1 in accordance with an embodiment of the present disclosure;

FIG. 4 illustrates a cross-sectional view of the insect trap of FIG. 1;

FIG. 5 illustrates an exemplary block diagram of the insect trap of FIG. 1;

FIG. 6 illustrates a perspective view of an insect trap in accordance with an embodiment of the present disclosure;

FIG. 7 illustrates another perspective view of the insect trap in the embodiment of FIG. 6;

FIG. 8 illustrates a side view of the insect trap of FIG. 6;

FIG. 9 illustrates an opposite side view of the insect trap of FIG. 6;

FIG. 10 is a cross-sectional view of the insect trap of FIG. 6; and

FIG. 11 is an exemplary block diagram of the insect trap of FIG. 6.

### DETAILED DESCRIPTION OF THE EXEMPLARY EMBODIMENTS

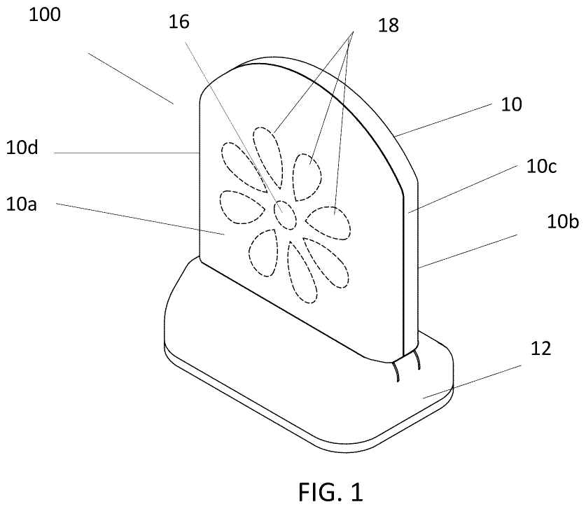

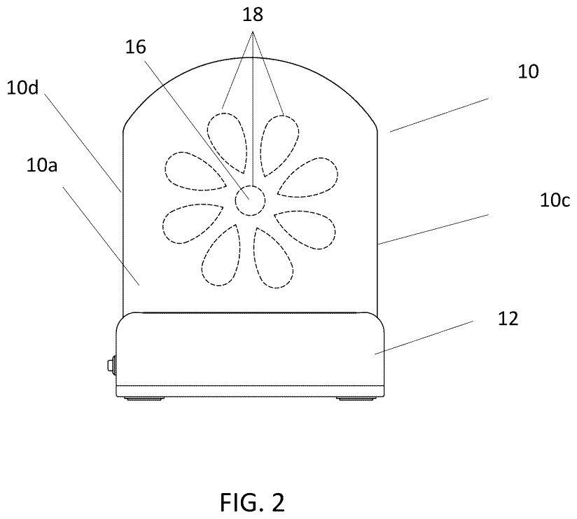

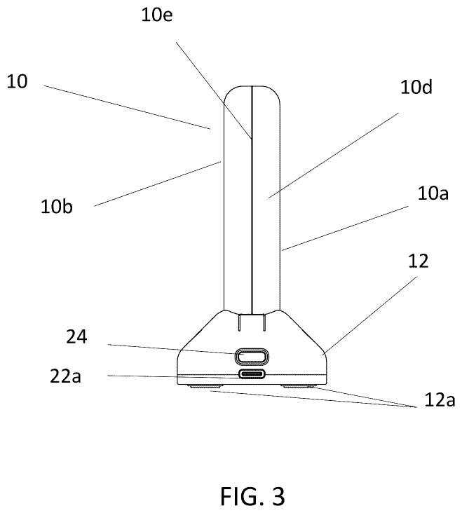

An insect trap 100 in accordance with an embodiment of the present disclosure is illustrated in FIG. 1, for example. In embodiments, a body 10 may include a front wall 10a and a rear wall 10b. A first sidewall 10c is positioned opposite a second sidewall 10d and the first sidewall and second sidewall are connected to the front wall 10a and the rear wall 10b. In embodiments, the first sidewall 10c and the second sidewall 10d may be integrated into the front wall 10a and/or the rear wall 10b. In embodiments, a seam 10e may be formed between the front wall 10a and the rear wall 10b and portions of the sidewall 10c, 10d to allow for separation thereof as generally indicated in FIG. 3. In embodiments, the first sidewall 10c and second sidewall 10d may be integrated into a single sidewall that connects the front wall 10a and the second wall 10b as generally shown in FIG. 1. In embodiments, the front wall 10a, rear wall 10b, first sidewall 10c and second sidewall 10d may be integrated together. In embodiments, the body 10 may be mounted in and extend upward from a base 12. In embodiments, the body 10 may be removably mounted in the base 12. A central cavity 16 is defined by the front wall 10a, rear wall 10b, first sidewall 10c, second sidewall 10d which cooperate to close the top of the body 10.

In embodiments, the front wall 10a includes one or more openings 18 allowing access to the central cavity 16. In embodiments, the central cavity 16 includes sticky or adhesive material. In embodiments, the sticky or adhesive material may be applied to an interior surface of one or more of the front wall 10a, the rear wall 10b, the first sidewall 10c and the second sidewall 10d. In embodiments, the sticky or adhesive material may be applied on or impregnated in a card or plate that is positioned in the central cavity 16 and may be removable. In embodiments, the openings 18 are sufficiently large to allow insects to enter the central cavity 16. In embodiments, the sticky or adhesive material traps an insect that comes into contact with it to hold it in place and prevent it from leaving the chamber 16. In embodiments, the sticky or adhesive material may be removable or may be re-applied when desired. In embodiments, the body 10 may be removed from the base 12 to allow for application of the sticky or adhesive material in the chamber 16. In embodiments, the body 10 may be removed from the base 12 to allow for removal and replacement of a card or plate including the sticky or adhesive material. In embodiments, the front wall 10a and rear wall 10b may be separated, along the seem 10e to allow access to the cavity 16 to provide or add the sticky or adhesive material.

In embodiments, a light 20 may be provided in the chamber 16. In embodiments, the light 20 may be provided at a bottom of the chamber 16. In embodiments, the light 20 may be provided in the base 12 to shine light into the chamber 16. In embodiments, the light 20 may include one or more light elements 20a that may be configured to emit light into the chamber 16. In embodiments, a cover or lens 22b may be provided above the light elements 20a through which light may shine. In embodiments, the cover or lens 20b may direct the light into the chamber 16. In embodiments, the light elements 20a may be light emitting diodes (LEDs), however any suitable light emitting element may be used. In embodiments, the light elements 20a may emit UV light. In embodiments, the light elements 20a may emit white light. In embodiments, the light elements 20a may emit light of another color.

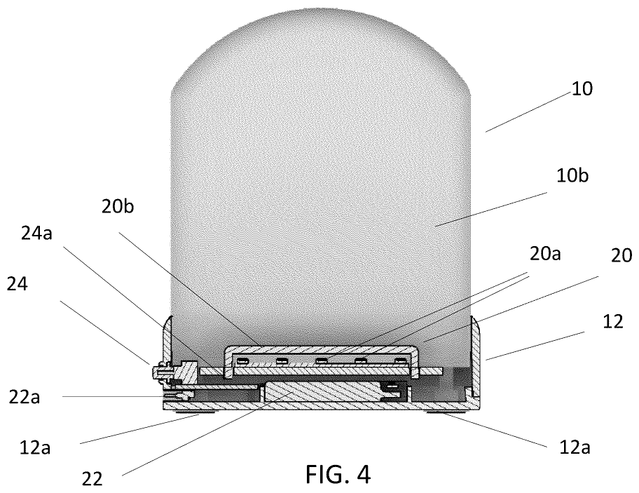

In embodiments, a power source 22 may be provided in the base 12 and electrically connected to the light elements 20a to power the light elements. In embodiments, the power source 22 may be a battery. In embodiment, the power source 22 may be a rechargeable battery. In embodiments, a charging port 22a may be provided in the base 12 and electrically connected to the power source 22 to recharge the power source. In embodiments, a charging circuit may be integrated into the port 22a (see FIG. 4, for example), or otherwise provided between the port and the power source 22 to control charging of the power source 22. In embodiments, the power source 22 may be any suitable power source including but not limited to a capacitor, a transformer, etc.

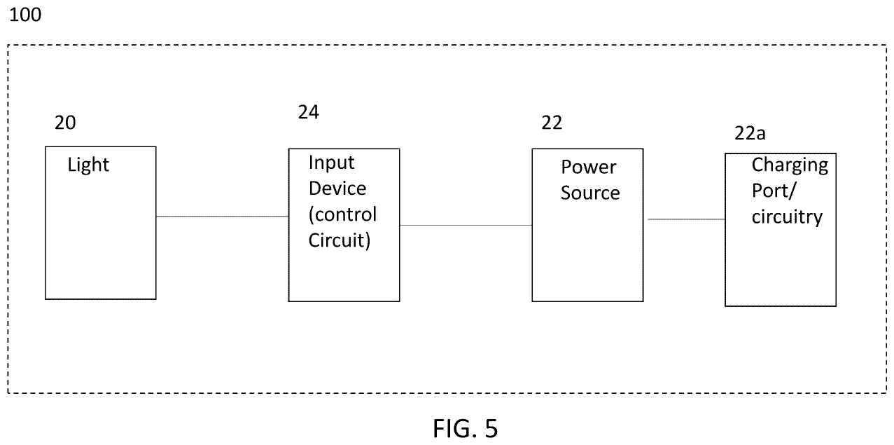

In embodiments, an input device 24 may be mounted in the base 12 and configured to provide an input to control operation of the light 20. In embodiments, the input device 24 may be a switch configured to selectively provide power to the light elements 20a from the power source 22. In embodiments, the input device 24 may be integrated with or otherwise connected to a control circuit to control flow of power to the light 20, including elements 20a (see FIG. 5, for example) based on input from the input device 24. In embodiments, the light elements 20a may be mounted on a circuit board 24a which may also include the control circuit and provided in or on the base 12. In embodiments, the light elements 20a may be operated based on a timer. In embodiments, the light elements 20a may be operated based on an ambient light level as detected by a light sensor, which may be operatively connected to the control circuit to provide light information. An example of light sensor is light sensor 240 discussed below.

In embodiments, the base 12 may include one or more legs or mounts 12a configured to allow the trap 100 to be mounted in or on any desired surface.

In operation, a user may actuate the input device 24 to provide power to the light 20 such that the light elements 20a light up to emit light to attract insects into the chamber 16. In embodiments, the light elements 20a may continue to emit light until the input device 24 is actuated again. In embodiments, the light elements 20a may continue to emit light for a predetermined period of time after the input device 24 is actuated.

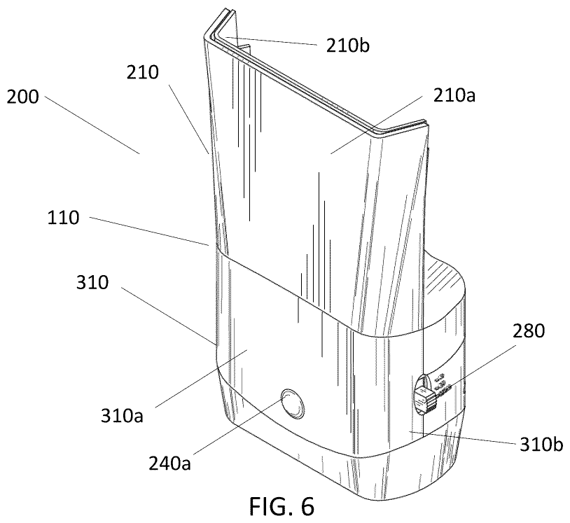

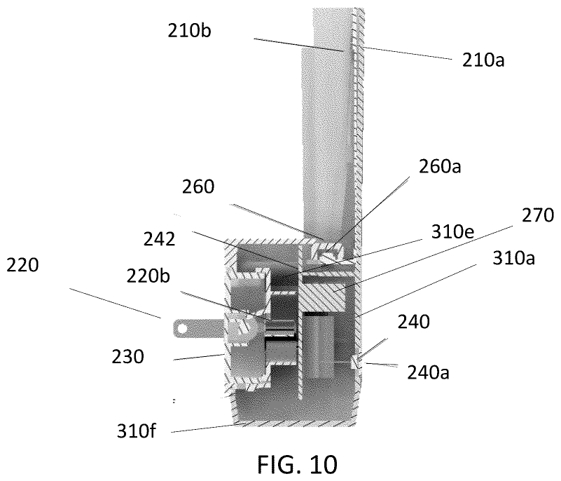

In embodiments, an insect trap 200 (see FIG. 6, for example) in accordance with another embodiment of the present application may be plugged into a wall outlet. In embodiments, the insect trap 200 may include a body 110 that includes an upper portion 210 and a lower portion 310. In embodiments, the upper portion 210 may include a front portion 210a facing outward with extensions on either side and an open top and rear. In embodiments, the lower portion 310 may include a front wall 310a positioned under the front portion 210a of the upper portion 210. In embodiments, the lower portion 310 also includes a first sidewall 310b and a second sidewall 310d, opposite the first sidewall, where the first sidewall and second sidewall connect the front wall 310a to a rear wall 310c. In embodiments, a bottom 310f may connect the front wall 310a, first sidewall 210b, rear wall 310c and second sidewall 310d and may be configured to allow the trap 200 to be free-standing when not connected to a wall outlet. In embodiments, the front wall 310a, first sidewall 210b, rear wall 310c, second sidewall 310d and top 310f define a chamber 310e (see FIG. 10, for example).

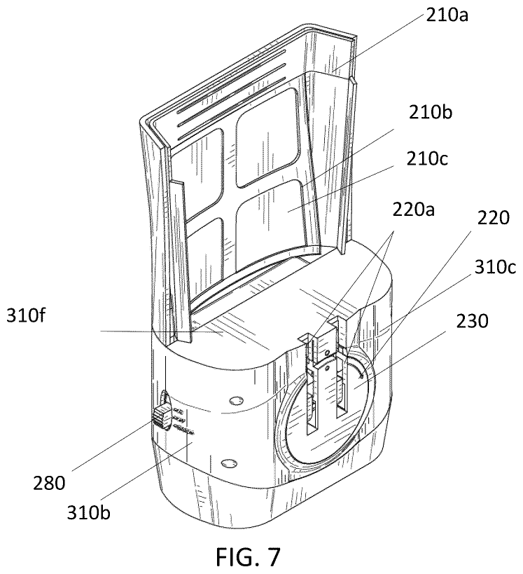

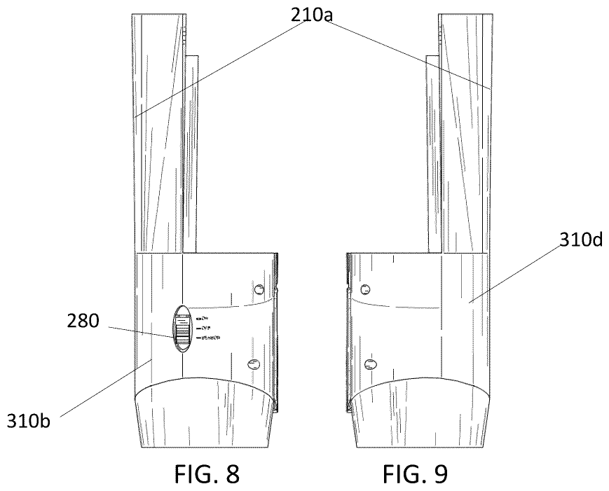

In embodiments, the rear wall 310c may include an electrical plug 220 (see FIGS. 7 and 10), or other electrical connector(s), suitable for connection to an outlet or other external power source. In embodiments, the electrical plug 220, or other connector(s), may be rotatably mounted to move from an open position in which the plug extends substantially perpendicularly outward from the rear wall 310c and a closed position in which the plug extends substantially parallel to the rear wall. In embodiments, the rear wall 310c may include recesses 220a (see FIG. 7, for example) in which the prongs of the plug 220 may be received in the closed position such that the plug is substantially flush with the surface of the rear wall in the closed position.

In embodiments, a sticky trap holder portion 210b may be provided in the upper portion 210 behind the front portion 210a. In embodiments, the sticky trap holder 210b may include a recess or chamber 210c (See FIG. 7, for example) in which a sticky material may be provided to trap insects. In embodiments, the sticky material may be coated on a card or plate that may be received in the chamber 210c. In embodiments, the card or plate may be similar to that used in the trap 100 discussed above. In embodiments, the sticky or adhesive material may be similar to that described above. In embodiments, the sticky trap holder portion 210b may be accessible from the open top of the front potion 210a such that the sticky material may be replaced. In embodiments, the sticky material may be provided in a replaceable cartridge or other device. In embodiments, the sticky trap holder portion 210b may be removably mounted behind the front portion 210a. In embodiments, the sticky trap holder 210b may be a cartridge that includes the sticky material allowing for removal and replacement of the sticky material along with the cartridge. In embodiments, the sticky or adhesive material may be provided on a card or plate that may be received in the sticky trap holder 210b and removable therewith.

In embodiments, the rear wall 310c may include a plug housing 230 (see FIG. 7, for example) in which the plug 220 is rotatably mounted. In embodiments, the recesses 220a may be provided, at least partially, in the plug housing 230. In embodiments, the plug 220 is connected to one or more contacts 220b that may be connected to other circuitry in the trap 200.

In embodiments, a light sensor 240 (see FIG. 10, for example) may be provided in or adjacent to the front wall 310a. In embodiments, a lens or cover 240a (see FIG. 6) may be provided in the front wall 310a to cover the light sensor 240 while allowing light to pass through. The light sensor 240 may be used to provide light information associated with an ambient light level around the trap 200.

In embodiments, a printed circuit board 242 (see FIG. 10), or other circuit board or boards may be mounted in the chamber 310e. In embodiments, light 260 may be mounted on a top of the lower portion 310 to direct light up toward the sticky trap holder 210b. In embodiments, the light 260 may be similar to the light 20 discussed above and may include one or more light elements 260a. In embodiments, the light emitted by the light 260 may be directed upward toward the sticky trap holder portion 210b to attract insects toward the sticky or adhesive material. In embodiments, control circuitry may be provided on or connected to the printed circuit board 242 and operably connected to the light 260 as well as the light sensor 240 and may control activation of the light elements 260a. In embodiments, the light elements 260a may be LEDs, however, any suitable light emitting elements may be used. In embodiments, a power source 270 may be provided on the printed circuit board 242, or elsewhere, and may power the light 260 as well as the light sensor 240. In embodiments, the power source 270 may be a battery, rechargeable battery or a capacitor. In embodiments, the power source 270 may be a transformer and may be operably connected to the plug 220, via the contacts 220b, for example, to provide an appropriate voltage to the light 260 and the light sensor 240 based on a line voltage or other voltage provided via the plug 220. In embodiments, the power source 270 may include a transformer and a rechargeable battery or capacitor that may be charged based on a voltage provided via the transformer from a line voltage or other voltage provided via the plug 220.

In embodiments, the first sidewall 310b may include an input device 280, such as a switch that may be used to control activation of the light 260. In embodiments, the input device 280 may be provided elsewhere. In embodiments, the switch may be used to place the trap 200 in an off state in which the light 260 may be off and no light may be emitted. The switch may be used to place the trap 200 in an on state in which the light source 260 may be on and the light elements 260a may emit light to attract insects toward the sticky trap holder portion 210b and the sticky material provided therein. In embodiments, in a light sensing state, which may also be set via the input device 280, activation of the light 260 may be based on a light level detected by the light sensor 240.

In embodiments, the circuit board 242 may be positioned elsewhere in the lower portion 310 or in the upper portion 210. In embodiments, the light sensor 240 may be positioned elsewhere in the lower portion 310 or in the upper portion 210. In embodiments, the power source 170 may be provided on the circuit board 242 or elsewhere in or on the lower portion 310 or the upper portion 210.

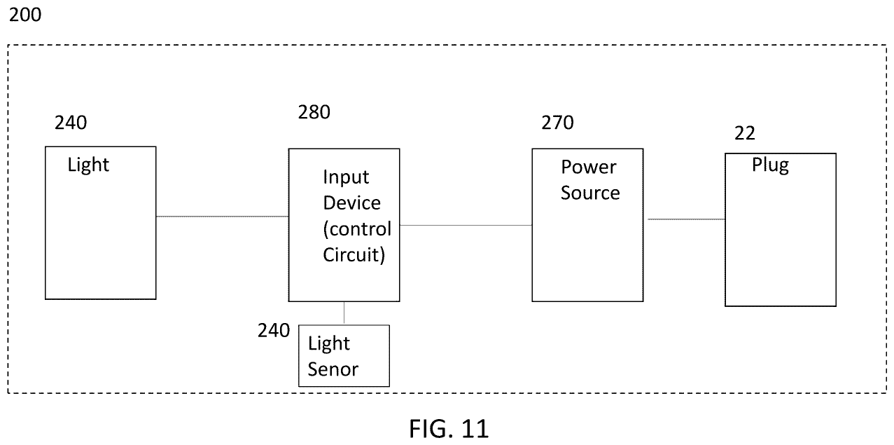

FIG. 11 illustrates an exemplary block diagram of the trap 200. In embodiments, a control circuit or circuitry may be provided on the circuit board 242 or elsewhere and operatively connected to input device 280 to allow user to control the trap 200. As noted above, in an off state, the light 260 is off and no light is emitted. In an on state, the control circuit activates the light 260 to emit light from the light elements 260a.

In embodiments, the power source 270 powers the light 240 as well as the control circuit or circuitry, and the light sensor 240. In a light sensing state, the light sensor 240, may provide information regarding an ambient light level around the trap 200 and the control circuit may activate the light source 260 when the light level drops below a threshold and may deactivate the light source when the light level exceeds the threshold as generally discussed above. In embodiments, the input element 280 may be physically separated from the control circuit, which may be on circuit board 242, but operatively connected thereto to provide input to the control circuit. In embodiments, the input element 280 may be a three-position switch, however, other input elements may be used. In embodiment, the light source 240 may emit light for a predetermined period of time.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. An insect trap comprising:
a base;
a body mounted in the base, the body including:
a front wall;
a rear wall mounted opposite the front wall;
at least one sidewall connecting the front wall and the rear wall;
wherein the front wall, rear wall at least one sidewall and base define a central chamber and the central chamber includes an adhesive material;
a light directing light into the central chamber to attract insects into the central chamber; and
a plurality of openings formed in at least one or the front wall and the rear wall configured to allow insects to pass not the central chamber.

2. The insect trap of claim 1, further comprising a power source mounted in the base and electrically connected to the light.

3. The insect trap of claim 2, further comprising a recharging circuit electrically connected to the power source and configured to charge the power source.

4. The insect trap of claim 3, wherein the base includes a charging port configured to receive a plug connected to a charging wire.

5. The insect trap of claim 1, wherein the adhesive material is provided on at least one of the front wall and the rear wall.

6. The insect trap of claim 1, further comprising an input element operably connected to the light and configured to turn the light on and off.

7. The insect trap of claim 1, wherein the light further comprises one or more light sources mounted in the base.

8. The insect trap of claim 1, further comprising a lens mounted in the base to direct light from the light into the central chamber.

9. The insect trap of claim 1, further comprising a substrate mounted in the central chamber, wherein the adhesive material is provided on the substrate.

10. The insect trap of claim 1, wherein the body is removable from the base to allow access to the central chamber.

11. An insect trap comprising:
a body,
wherein the body incudes a lower portion and an upper portion mounted on the lower portion,
the lower portion including:
a chamber:
a plug extending from a rear of the lower portion and configured for electrical connection to an electrical outlet; and
a light mounted on a top of the lower portion and configure to emit light;
the upper portion including:
a front wall;
a trap holder mounted behind the front wall including a recess including an adhesive material, wherein light from the light portion is projected toward the trap holder to attract insects to the adhesive material.

12. The insect trap of claim 11, wherein the lower portion includes:
a front wall;
a first sidewall connected to the front wall;
a second sidewall connected to the front wall opposite the first sidewall;
a rear wall connecting the first sidewall and second sidewall; and\
a bottom wall connecting the front wall,
wherein the chamber is defined by the front wall, first sidewall, second sidewall, rear wall and bottom wall.

13. The insect trap of claim 12, further comprising a plug housing provided in the rear wall and the plug extends from the plug housing.

14. The insect trap of claim 13, wherein the plug is pivotally attached to the plug housing to move from an extended position in which the plug extends substantially perpendicular to the rear wall and a second position in which the plug is received in a recess in the plug housing such that it is flush with the rear wall.

15. The insect trap of claim 11, further comprising a control circuit mounted in the chamber and connected to the light to control emission of light.

16. The insect trap of claim 15, further comprising a printed circuit board, wherein the control circuit provided on the printed circuit board.

17. The insect trap of claim 16, further comprising a power source operably connected to the control circuit and the light to provide power to the control circuit and the power source.

18. The insect trap of claim 17, further comprising a first input device connected to the control circuit and configured to receive input from a user to control the light.

19. The insect trap of claim 18, wherein the first input device is a three position switch used to activate the light, deactivate the light and the light on a timer.

20. The insect trap of claim 15, further comprising a light sensor connected to the control circuit and configured to provide light information associated with a light level around the insect trap, wherein the control circuit activates the light based on the light information.

21. The insect trap of claim 15, wherein the control circuit activates the light for a predetermined period of time.
